(19) United States
(12) Patent Application Publication
(10) Pub. No.: US 2012/0069111 A1
(43) Pub. Date: Mar. 22, 2012

(54) INKJET RECORDING APPARATUS AND INKJET RECORDING METHOD

(75) Inventors: Yoshiaki Kaneko, Shizuoka-ken (JP); Hirofumi Kondo, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/231,005

(22) Filed: Sep. 13, 2011

Related U.S. Application Data
(60) Provisional application No. 61/384,046, filed on Sep. 17, 2010.

(51) Int. Cl. B41J 2/01

(52) U.S. Cl. 347/104

(57) ABSTRACT

According to one embodiment, an inkjet recording apparatus includes a holding roller, a holding device, an image forming device, a reversing device, and a controller. The holding roller holds a recording medium. The holding device presses the recording medium and holds the recording medium on the surface of the holding roller. The controller performs control to press the recording medium against the holding roller with first pressing force if the image forming device forms an image on a first surface of the recording medium and press the recording medium against the holding roller with second pressing force smaller than the first pressing force if the image forming device forms an image on a second surface of the recording medium after the image is formed on the first surface of the recording medium and the recording medium is reversed by the reversing device.

### CROSS-REFERENCE TO RELATED APPLICATIONS

This application claims the benefit of U.S. Provisional Application No. 61/384,046, filed on Sep. 17, 2010.

### FIELD

Embodiments described herein relate generally to an inkjet recording apparatus and an inkjet recording method.

### BACKGROUND

There is an inkjet recording apparatus that rotates a holding roller having a recording medium such as a sheet held on the surface thereof to thereby convey the recording medium along the outer circumference of the holding roller and performs image formation in an image forming section provided in the outer circumferential portion of the holding roller.

The inkjet recording apparatus presses, for example, with a holding device including a pressing mechanism and an attraction mechanism, the recording medium against the surface of the holding roller to bring the recording medium into close contact the surface of the holding roller and attracts the recording medium to the surface of the holding roller to thereby hold the recording medium on the surface of the holding roller.

As such an inkjet recording apparatus, there is a duplex printing inkjet recording apparatus that includes a reversing device configured to reverse the recording medium, reverses the front and rear surfaces of the recording medium after forming an image on one principal plane of the recording medium, and holds the recording medium on the surface of the holding roller again to form an image on the other principal plane. The duplex printing inkjet recording apparatus presses the surface of the recording medium, to which ink is supplied, against the holding roller. If pressing force for pressing the recording medium against the holding roller is large, the ink is transferred onto the holding roller and causes deterioration in image quality or the like.

### BRIEF DESCRIPTION OF THE DRAWINGS

FIG. 1 is an explanatory diagram of the configuration of an inkjet recording apparatus according to a first embodiment;

FIG. 2 is a block diagram showing a system configuration of the inkjet recording apparatus;

FIG. 3 is a flowchart for explaining a control procedure by a CPU in an inkjet recording method according to the embodiment; and

FIG. 4 is a flowchart for explaining adjustment processing of the inkjet recording method according to the embodiment.

### DETAILED DESCRIPTION

In general, according to one embodiment, an inkjet recording apparatus includes a holding roller, a conveying device, a holding device, an image forming device, a reversing device, and a controller. The holding roller holds a recording medium on the surface thereof and rotates. The conveying device conveys the recording medium along a conveying path including the outer circumferential portion of the holding roller. The holding device presses the recording medium against and holds the recording medium on the surface of the holding roller. The image forming device ejects ink to the recording medium held on the surface of the holding roller and forms an image on the recording medium. The reversing device reverses the front and rear surfaces of the recording medium. The controller performs control to press the recording medium against the holding roller with first pressing force if the image forming device forms an image on a first surface of the recording medium and press the recording medium against the holding roller with second pressing force smaller than the first pressing force if, after the reversing device reverses the recording medium after the image is formed on the first surface of the recording medium, the image forming device forms an image on a second surface of the recording medium.

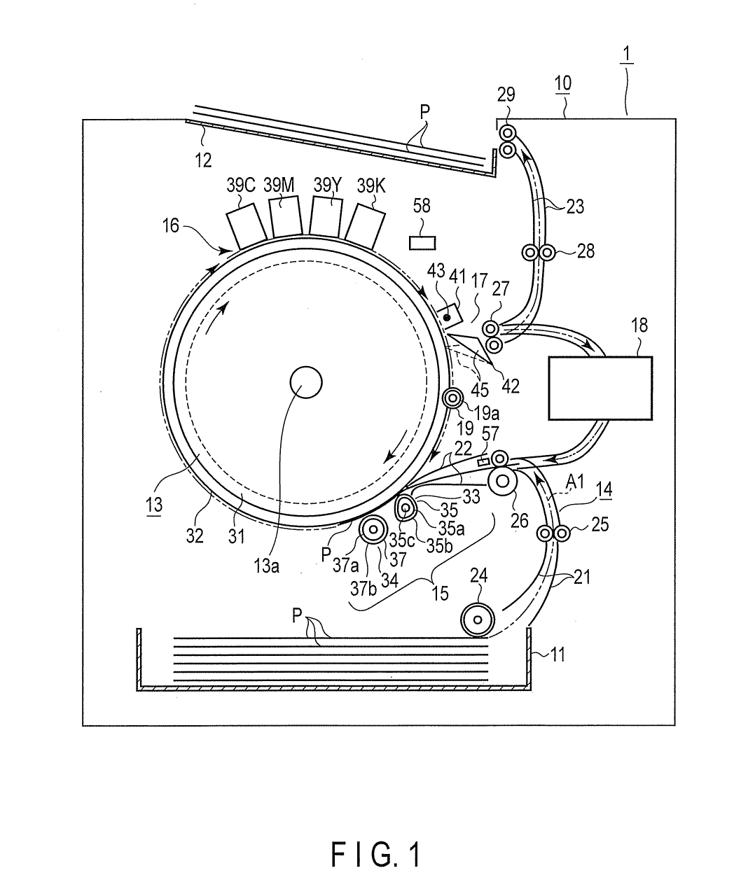

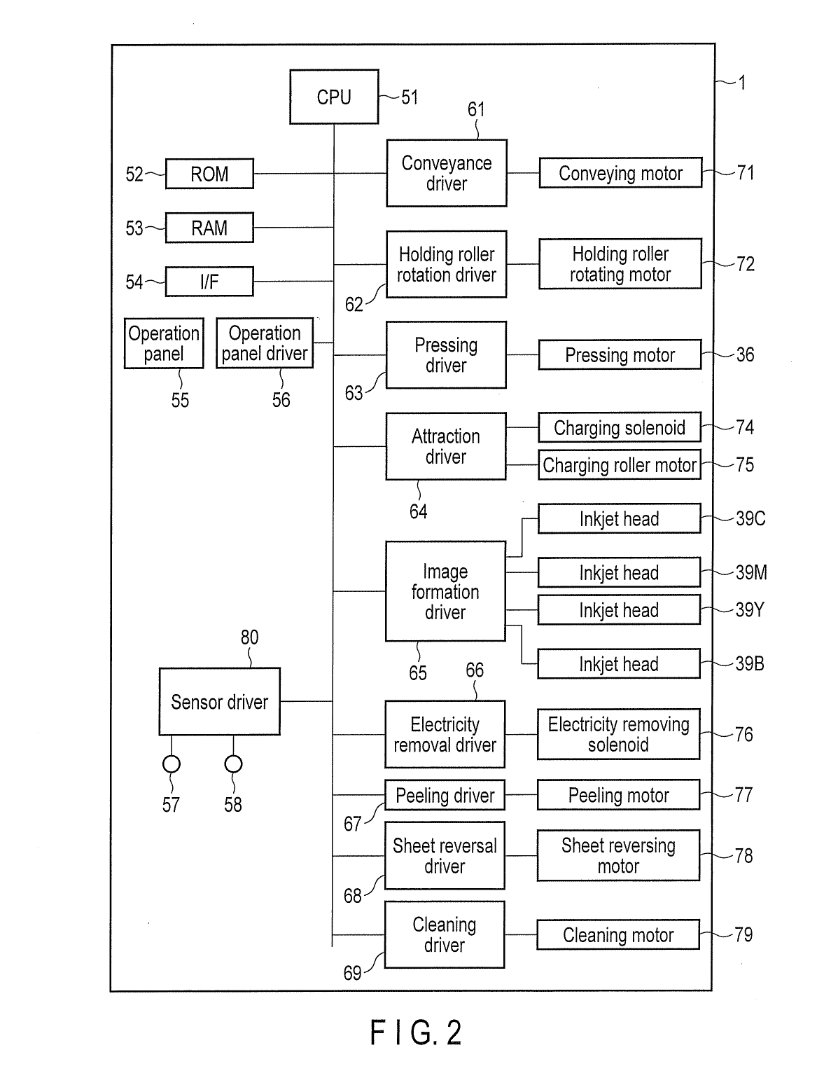

An inkjet recording apparatus 1 according to the first embodiment is explained below. In the figures, components are schematically shown by enlarging, reducing, or omitting the components as appropriate. FIG. 1 is an explanatory diagram of a mechanism of the inkjet recording apparatus 1 according to this embodiment. FIG. 2 is a block diagram of a system of the inkjet recording apparatus 1.

The inkjet recording apparatus 1 shown in FIG. 1 is, for example, an apparatus that performs various kinds of processing such as image formation while conveying a sheet P, which is a recording medium. The inkjet recording apparatus 1 includes a housing 10 forming an outer hull, a paper feeding cassette 11 functioning as a sheet feeding section provided on the inside of the housing 10, a paper discharge tray 12 functioning as a discharge section provided in an upper part of the housing 10, a holding roller (drum) 13 configured to hold the sheet P on the outer surface thereof and rotate, a conveying device 14 configured to convey the sheet P along a predetermined conveying path A1 formed from the paper feeding cassette 11 to the paper discharge tray 12 through the outer circumference of the holding roller 13, and a reversing device 18 configured to reverse the front and rear surfaces of the sheet P peeled off the holding roller 13 and feed the sheet P onto the surface of the holding roller 13 again.

In the outer circumferential portion of the holding roller 13, in order from an upstream side to a downstream side, there are provided a holding device 15 configured to press the sheet P against the outer surface of the holding roller 13 and attract the sheet P to the surface (the outer circumferential surface) of the holding roller 13 to hold the sheet P, an image forming device 16 configured to form an image on the sheet P held on the outer surface of the holding roller 13, an electricity removing and peeling device 17 configured to remove electricity from the sheet P and peel the sheet P off the holding roller 13, and a cleaning device 19 configured to clean the holding roller 13.

The conveying device 14 includes plural guide members 21 to 23 and plural conveying rollers 24 to 29 provided along the conveying path A1. As the conveying rollers, a pickup roller 24, a paper feeding roller pair 25, a registration roller pair 26, a separating roller pair 27, a conveying roller pair 28, and discharge roller pair 29 are provided. The conveying rollers 24 to 29 are driven to rotate by a conveying motor 71 to feed the sheet P to the downstream side along the conveying path A1.

A sheet position sensor 57 configured to detect a leading end position of the sheet P is provided near a nip of the registration roller pair 26 in the conveying path A1. An operation panel 55 with which a user can set various items is provided. A temperature sensor 58 functioning as a temperature detecting section configured to detect temperature in the apparatus 1 is provided in the apparatus 1. Besides, a sensor for monitoring a conveyance state of a sheet and the like are arranged in various places.

The holding roller 13 includes a rotating shaft 13a, a cylindrical frame 31 formed of aluminum, which is a conductor, in a cylindrical shape, and a thin insulating layer 32 formed on the surface of the cylindrical frame 31. The holding roller 13 is formed in a cylindrical shape having fixed length in an axis direction. The cylindrical frame 31 is grounded. During charging by the charging roller 37, the cylindrical frame 31 functions as a counter electrode and the potential of the cylindrical frame 31 is maintained at 0 V. The holding roller 13 rotates in a state in which the sheet P is held on the surface thereof to thereby convey the sheet P. The holding roller 13 rotates clockwise in FIG. 1 to thereby convey the sheet P clockwise along the outer circumference of the holding roller 13.

The holding device 15 includes a pressing device 33 configured to press the sheet P against the holding roller 13 and an attraction device 34 configured to attract the sheet P to the holding roller 13 with electrostatic force by charging on the downstream side of the pressing device 33 in a direction in which the sheet P is conveyed.

The pressing device 33 includes a rotating shaft 35c, a pressing roller 35 (a pressing member) arranged to be opposed to the surface in a lower part of the holding roller 13, and a pressing motor 36 explained later configured to drive the pressing roller 35.

The pressing roller 35 includes a cam, a distance from the rotating shaft to the outer circumferential surface of which changes in plural stages. The pressing roller 35 can be switched, according to a rotation angle thereof, among a first state in which the pressing roller 35 presses the surface of the holding roller 13 with first pressing force, a second state in which the pressing roller 35 presses the surface of the holding roller 13 with second pressing force smaller than the first pressing force, and a third state in which the pressing roller 35 separates from the holding roller 13 and releases pressing force.

A load applied between the pressing roller 35 and the holding roller 13 is set to a proper value at which the sheet P is not deformed and image quality is not deteriorated. When the sheet P passes through a nip section between the holding roller 13 and the pressing roller 35, the sheet P is pressed against the holding roller 13 by the pressing roller 35, whereby the sheet P adheres to the surface of the holding roller 13 while creases thereof are smoothed.

The outer circumferential surface of the pressing roller 35 is covered with an insulating layer 35b, which is made of an insulating material, to prevent charges of the charged sheet P from leaking through the pressing roller 35.

The attraction device 34 includes a charging roller 37 arranged adjacent to the downstream side of the pressing roller 35. The charging roller 37 includes a chargeable charging shaft 37a of metal extending in parallel to the rotating shaft 13a and a surface layer section 37b formed on the outer circumference of the charging shaft 37a. The charging roller 37 is arranged to be opposed to the surface of the holding roller 13. It is possible to switch a supply state of charges to the charging roller 37 and move the charging roller 37 in directions in which the charging roller 37 approaches and separates from the surface of the holding roller 13.

If electric power is supplied to the charging roller 37 in a state in which the charging roller 37 approaches the holding roller 13, a potential difference occurs between the charging roller 37 and the grounded cylindrical frame 31 to generate electrostatic force in a direction in which the sheet P is attracted to the holding roller 13 (charging). The sheet P is attracted to the surface of the holding roller 13 by the electrostatic force.

The image forming device 16 includes plural inkjet heads 39c, 39m, 39y, and 39b arranged further on the downstream side than the charging roller 37 to be opposed to an upper portion of the surface of the holding roller 13. The inkjet heads 39c, 39m, 39y, and 39b for four colors of cyan, magenta, yellow, and black are provided. The inkjet heads 39c, 39m, 39y, and 39b for the four colors eject inks from nozzles provided at a predetermined pitch to the sheet P and form an image.

The electricity removing and peeling device 17 includes an electricity removing device 41 configured to perform electricity removal for the sheet P and a peeling device 42 configured to peel the sheet P off the surface of the holding roller 13 after the electricity removal.

The electricity removing device 41 is provided further on the downstream side in the direction in which the sheet P is conveyed than the image forming device 16 and includes a chargeable electricity removing roller 43. The electricity removing device 41 supplies charges and removes electricity from the sheet P to release attracting force and make it easy to peel the sheet P off the holding roller 13.

The peeling device 42 is provided on the downstream side of the electricity removing device 41 and includes a pivotable (movable) separation claw 45. The separation claw 45 is pivotable between a peeling position where the separation claw 45 is inserted between the sheet P and the holding roller 13 and a retracted position where the separation claw 45 retracts from the holding roller 13. In a state in which the separation claw 45 is arranged in the peeling position, the separation claw 45 peels the sheet P off the surface of the holding roller 13. In FIG. 1, a state in which the separation claw 45 is present in the peeling position is indicated by a broken line and a state in which the separation claw 45 is present in the retracted position is indicated by a solid line.

The cleaning device 19 is provided further on the downstream side than the electricity removing and peeling device 17 and includes a cleaning member 19a movable between a contact position where the cleaning member 19a is in contact with the holding roller 13 and a separation position where the cleaning member 19a retracts from the holding roller 13 and a cleaning motor 79 configured to drive the cleaning member 19a. The holding roller 13 rotates in a state in which the cleaning member 19a is in contact with the surface of the holding roller 13, whereby the cleaning member 19a cleans the surface of the holding roller 13.

The reversing device 18 is provided on the downstream side of the peeling device 42, reverses the sheet P peeled by the peeling device 42, and feeds the sheet P onto the surface of the holding roller 13 again. For example, the reversing device 18 guides and conveys the sheet P along a predetermined reversing path for switching back the sheet P reversely in the front back direction to thereby reverse the sheet P.

As shown in FIG. 2, the inkjet recording apparatus 1 includes a CPU (central processing unit) 51, which is a controller, a ROM (read only memory) 52 having various computer programs and the like stored therein, a RAM (random access memory) 53 configured to temporarily store various variable data, image data, and the like, and an interface (I/F) 54 configured to receive input of data from the outside and output data to the outside.

The inkjet recording apparatus 1 includes a conveying motor control driving circuit (driver) 61 configured to control a conveying roller motor 71 coupled to the rollers 24 to 29 functioning as the conveying rollers, a holding roller control driving circuit (driver) 62 configured to control a holding roller rotating motor 72 coupled to the holding roller 13, a pressing motor control driving circuit (driver) 63 configured to control the pressing motor 36 coupled to the pressing roller 35, an attraction control driving circuit (driver) 64 configured to control a charging roller motor 75 coupled to a charging solenoid 74 and the charging roller 37 connected to the attraction device 34, an image formation control driving circuit (driver) 65 configured to control the inkjet heads 39c, 39m, 39y, and 39b, an electricity removal control driving circuit (driver) 66 configured to control an electricity removing solenoid 76 connected to the separation claw 45, a peeling control driving circuit (driver) 67 configured to control a peeling motor 77 coupled to the separation claw 45, a sheet reversal driver 68 configured to control a sheet reversing motor 78 coupled to the reversing device 18, a cleaning control driving circuit (driver) 69 configured to control a cleaning motor 79 coupled to the cleaning member 19a, a sensor control driving circuit (driver) 80, and an operation panel control driving circuit (driver) 56 configured to control the operation panel 55.

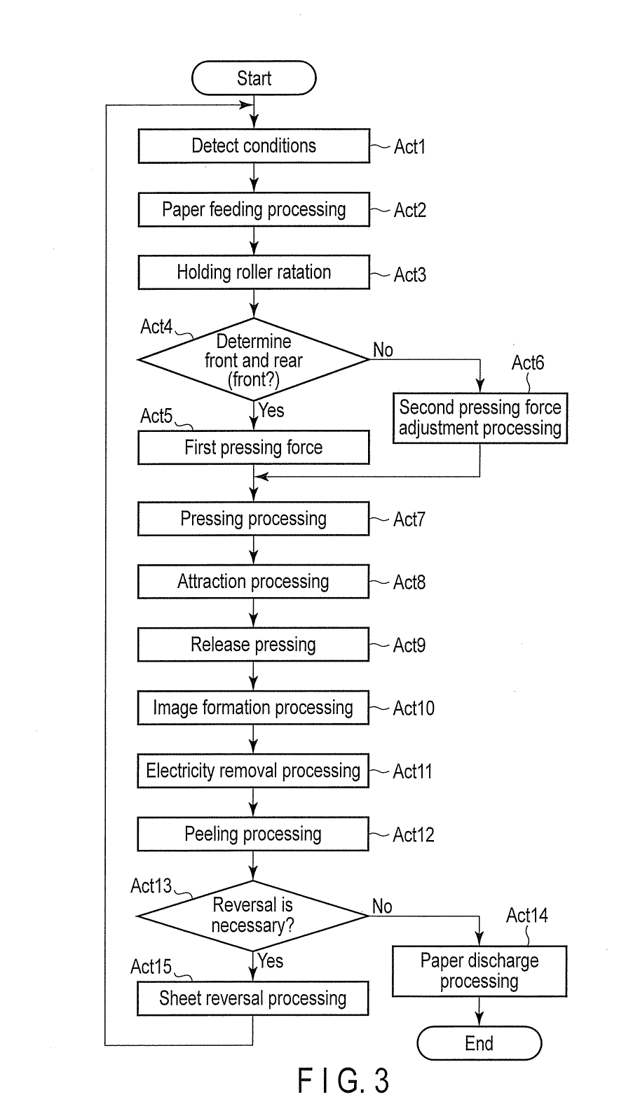

An inkjet recording method according to this embodiment is explained below with reference to a flowchart of FIG. 3 for explaining a control procedure by the CPU 51.

First, the CPU 51 detects various conditions (Act 1). The conditions are, besides necessity of duplex printing, for example, a printing ratio, a color, printing speed, the resolution of image formation, the thickness of the sheet P, and the temperature in the apparatus 1. The CPU 51 detects these conditions from information detected by the sensor 57 or information input from the interface 54.

For example, the CPU 51 detects, on the basis of a setting input by the user, conditions such as the thickness of the sheet P, a printing mode of duplex printing or simplex printing, the resolution of image formation, and a color mode via the interface 54.

The CPU 51 determines conditions such as a printing ratio, a color, and printing speed on the basis of information concerning an image to be printed and information such as resolution. Besides, the CPU 51 detects, with the other sensors 57 and 58, conditions such as the position of the sheet P and the temperature in the apparatus.

Subsequently, the CPU 51 performs paper feeding processing (Act 2). In the paper feeding processing, the CPU 51 drives to rotate the pickup roller 24, the paper feeding roller pair 25, and the registration roller pair 26, which function as the conveying rollers, to thereby send one sheet P from a sheet bundle stacked on the paper feeding cassette 11 along the conveying path A1 and feed the sheet P onto the surface of the holding roller 13.

Then, the CPU 51 drives to rotate the holding roller 13 (Act 3).

The CPU 51 determines, on the basis of the condition of the necessity of duplex printing detected in Act 1, whether the present image formation is performed on the front surface (a first surface) (Act 4). If the CPU 51 determines that the present image formation is performed on the front surface (YES in Act 4), the CPU 51 sets adjustment processing such that the pressing roller 35 presses the holding roller 13 with first pressing force (Act 5). If the CPU 51 determines that the present image formation is not performed on the front surface, i.e., the image formation is performed on the rear surface (a second surface) (NO in Act 4), the CPU 51 sets the adjustment processing such that the pressing roller 35 presses the holding roller 13 with second pressing force weaker (lower) than the first pressing force (Act 6).

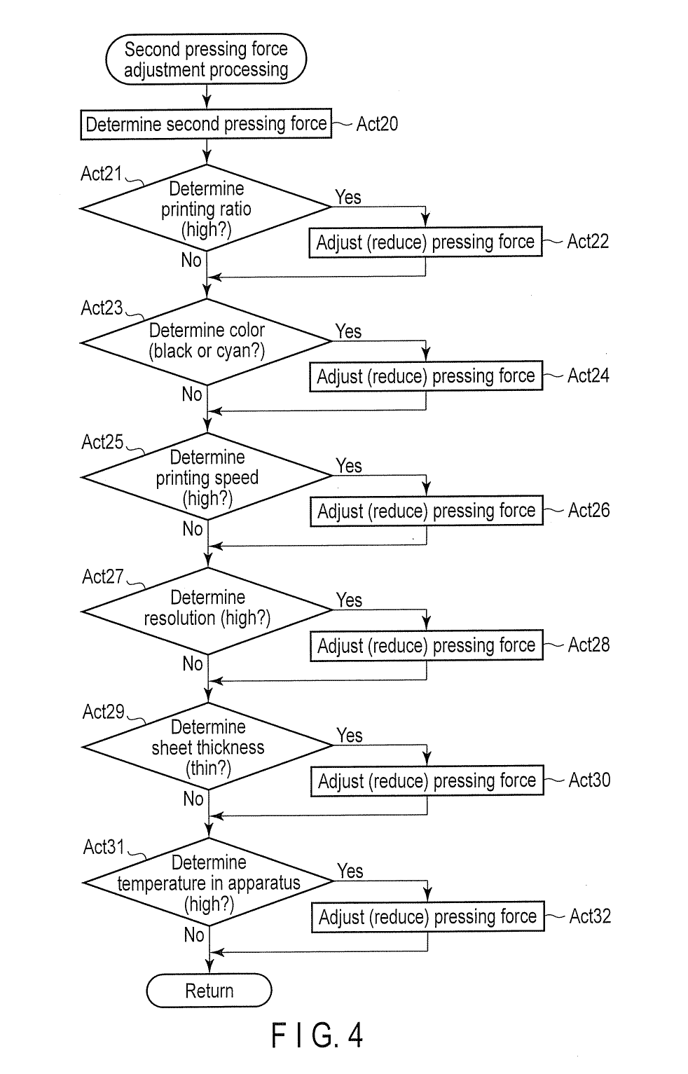

The adjustment processing for the second pressing force in Act 6 is explained with reference to FIG. 4. The adjustment of the second pressing force is performed according to various conditions on the basis of the information from the sensor 57 and the interface 54 detected in Act 1.

First, the CPU 51 sets the second pressing force weaker (lower) than the first pressing force (Act 20).

Subsequently, the CPU 51 determines a printing ratio (Act 21). If the CPU 51 determines that the printing ratio is higher than a threshold set in advance (YES in Act 21), the CPU 51 adjusts the second pressing force to be lower than a reference value set to a value smaller than the first pressing force (Act 22). On the other hand, if the CPU 51 determines that the printing ratio is lower than the threshold (NO in Act 21), the CPU 51 proceeds to Act 23 while keeping the second pressing force at the reference value without performing adjustment.

The CPU 51 determines printing speed (Act 23). If the CPU 51 determines that the printing speed is higher than a threshold set in advance (YES in Act 23), the CPU 51 adjusts the second pressing force to be lower (Act 24). If the CPU 51 determines that the printing speed is lower than the threshold (NO in Act 23), the CPU 51 proceeds to Act 25 without performing adjustment.

The CPU 51 determines a color of printing (Act 25). In color determination processing, for example, if the CPU 51 determines that a printing mode is a single color mode of cyan or black that substantially affects image quality (if the CPU 51 determines that the printing ratio is higher than the threshold set in advance) (YES in Act 25), the CPU 51 adjusts the second pressing force to be lower (Act 26). If the color is any one of the other colors (NO in Act 25), the CPU 51 proceeds to Act 27 without performing adjustment. An example in the case of the single color is explained. However, if the CPU 51 determines that the printing ratio is higher than a threshold set in advance in full-color, the CPU 51 may perform the same processing.

The CPU 51 determines the resolution of image formation (Act 27). If the CPU 51 determines that the resolution is higher than a threshold set in advance (YES in Act 27), the CPU 51 adjusts the second pressing force to be lower (Act 28). On the other hand, if the CPU 51 determines that the resolution is lower than the threshold (NO in Act 27), the CPU 51 proceeds to Act 29 without performing adjustment.

The CPU 51 determines the thickness of the sheet P (Act 29). If the CPU 51 determines that the thickness of the sheet P is smaller than a threshold set in advance (YES in Act 29), the CPU 51 adjusts the second pressing force to be lower (Act 30). On the other hand, if the CPU 51 determines that the thickness of the sheet P is larger than the threshold (NO in Act 29), the CPU 51 proceeds to Act 31 without performing adjustment.

The CPU 51 determines the temperature in the apparatus (Act 31). If the CPU 51 determines that the temperature in the apparatus is higher than a threshold set in advance (YES in Act 31), the CPU 51 adjusts the second pressing force to be lower (Act 32). If the CPU 51 determines that the temperature in the apparatus is lower than the threshold (NO in Act 31), the CPU 51 does not perform adjustment. Consequently, the adjustment processing for the second pressing force ends and the second pressing force is adjusted to a proper value corresponding to the various conditions.

Referring back to FIG. 3, the CPU 51 instructs the pressing motor control driving circuit (driver) 63 to allow the pressing roller 35 to press the holding roller 13 with the pressing force determined in Act 5 or Act 6 (Act 7).

For example, in the case of a state in which the front surface of the sheet P before reversal is faced out, a load of the pressing roller 35 is set to the first pressing force. Therefore, the position of the pressing roller 35 is set in the first state. First, the sheet P sent by the registration roller pair 25 twines around and adheres to the holding roller 13 while unevenness such as creases thereof is smoothed by the pressing roller 35. The sheet P passes through the nip between the pressing roller 35 and the holding roller 13 and immediately rushes into a nip between the charging roller 37 and the holding roller 13 on the downstream side.

Subsequently, the CPU 51 instructs the attraction control driving circuit 64 to generate electrostatic force in the nip between the charging roller 37 and the holding roller 13 and attract the sheet P (Act 8). Timing of charging is set, for example, such that the sheet P is charged immediately before the sheet P reaches the charging roller 37 according to the rotation of the holding roller 13. The attracted and held sheet P is directly conveyed to the image forming device 16 according to the rotation of the holding roller 13.

The CPU 51 instructs the pressing motor control driving circuit 63 to retract the pressing roller 35 at predetermined timing when the trailing end of the sheet P moves further to the downstream side than the pressing roller 35 (Act 9).

Subsequently, the CPU 51 performs image formation processing (Act 10). In the image formation processing, the CPU 51 causes the inkjet heads 39c, 39m, 39y, and 39b to eject the inks to the surface of the sheet P and instructs the image formation control driving circuit 65 to perform printing. The CPU 51 performs image formation according to various conditions such as resolution and a printing mode. According to necessity, the CPU 51 rotates the holding roller 13 plural times with the sheet P kept attracted to the holding roller 13 and repeats the image forming operation by the inkjet heads 39c, 39m, 39y, and 39b plural times. A necessary number of revolutions and a necessary number of times of ejection are determined according to, for example, a nozzle pitch of the inkjet heads 39c, 39m, 39y, and 39b and resolution. When the holding roller 13 is rotated plural times with the sheet P kept attracted to the holding roller 13, the separation claw 45 of the electricity removing and peeling device 17 and the cleaning member 19a of the cleaning device 19 are set in the retracted position to allow conveyance of the sheet P.

After the end of the image formation processing, the CPU 51 drives the electricity removing device 41 arranged on the downstream side of the image forming device 16 (Act 11). By driving the electricity removing device 41, the CPU 51 removes the electricity of the sheet P and releases electrostatic attraction force. The CPU 51 drives the peeling device 42 on the downstream side (Act 12). By driving the peeling device 42, the CPU 51 peels the sheet P off the surface of the holding roller 13.

Subsequently, the CPU 51 determines necessity of reversal of the sheet P (Act 13). If the CPU 51 determines that the reversal of the sheet P is unnecessary (NO in Act 13), the CPU 51 performs paper discharge processing (Act 14). For example, during simplex printing setting or after image formation on both the front and rear surfaces ends in duplex printing setting, the CPU 51 determines that the reversal is unnecessary. As the paper discharge processing, the CPU 51 switches the separating roller pair 27 to thereby guide the sheet P to a conveying path connected to the paper discharge tray 12 in an upper part and discharges the sheet P to the paper discharge tray 12 through the conveying roller pair 28 and the paper discharge roller pair 29.

On the other hand, if the CPU 51 determines that the reversal of the sheet P is necessary (YES in Act 13), the CPU 51 instructs the reversing device 18 to perform reversal processing (Act 15). As the reversal processing, the CPU 51 switches the separating roller pair 27 to thereby guide the sheet P to the conveying path A1 connected to the reversing device 18 and causes the reversing device 18 to reverse the front and rear surfaces of the sheet P. For example, the reversing device 18 temporarily stores the sheet P and guides the sheet P to the reversing path, in which the sheet P is switched back from the trailing end, to thereby reverse the front and rear surfaces of the sheet P.

After the reversal processing, the CPU 51 returns to Act 3. The CPU 51 performs the processing in Acts 4 to 13 again. Since the rear surface of the sheet P is on the outer side after the reversal processing, the CPU 51 determines in Act 4 that the image formation is not performed on the front surface. The CPU 51 sets the adjustment processing such that the pressing roller 35 presses the holding roller 13 with second pressing force. In Act 7, although ink already adheres to the surface of the sheet P through the image formation, since the pressing force after the reversal processing is set low, it is possible to prevent transfer of the ink and deformation and positional deviation of the sheet P. After the image formation processing on the rear surface ends, since the reversal is unnecessary, the CPU 51 determines that the reversal is unnecessary (NO in Act 13) and performs the paper discharge processing (Act 14).

After the sheet P is peeled, the CPU 51 cleans the surface of the holding roller 13 with the cleaning device 19 provided further on the downstream side. The holding roller 13 rotates while being in contact with the cleaning member 19a, whereby the cleaning device 19 cleans the surface of the holding roller 13.

With the inkjet recording apparatus 1 and the inkjet recording method according to this embodiment, when the sheet P, to the surface of which the ink is supplied according to the image formation, is subjected to the reversal processing and held on the holding roller 13 again, pressing force is set small. Therefore, it is possible to prevent the ink supplied to the surface from being transferred onto the holding roller 13 and suppress deterioration in image quality.

In general, the sheet P undergone an image forming process tends to be deformed by moisture absorption. Therefore, if pressing force is large when the sheet P is pressed against the holding roller 13 again, in some cases, the sheet P extends in a conveying direction of the sheet P and is, for example, curled to be deformed. In this embodiment, since pressing force for the sheet P after being subjected to image formation once is set small, it is possible to suppress deformation, prevent positional deviation and a jam, and perform stable processing.

In this embodiment, in particular, in a situation in which ink supplied to the surface of the sheet P in first printing less easily dries, for example, if a printing ratio is high, printing speed is high, temperature is high, or the sheet P is thin, pressing force for pressing the rear surface in second printing is adjusted to be lower. Therefore, a large effect is obtained in preventing inconveniences such as deformation and positional deviation of the sheet P and transfer of the ink.

All of the pressing roller 35, the charging roller 37, the separation claw 45, and the cleaning member 19a can come into contact with and separate from the surface of the holding roller 13. Therefore, it is possible to prevent the pressing roller 35, the charging roller 37, the separation claw 45, and the cleaning member 19a from coming into contact with an image surface after image formation and prevent damage to the sheet P and deterioration in image quality.

The present invention is not limited to the embodiment and can be modified as appropriate. In the illustrative explanation in the embodiment, as the adjustment processing for the second pressing force, the determination processing is performed concerning the conditions such as a printing ratio, a color, printing speed, resolution, sheet thickness, and temperature in this order. However, the present invention is not limited to this. This adjusting operation may be omitted or any one of the illustrated plural conditions may be omitted. Further, the second pressing force may be adjusted on the basis of other conditions.

In the embodiment, as the pressing device 33, the configuration including the cam capable of adjusting pressing force in plural stages according to a rotation angle is illustrated. However, the present invention is not limited to this.

In the embodiment, as the holding device 15, the holding device including the pressing device 33 and the attraction device 34 is illustrated. However, the present invention is not limited to this. For example, the holding device may have a configuration including a charging and pressing roller (a charging and pressing member) configured to be chargeable and configured to be capable of pressing the sheet P against the holding roller 13. Specifically, the charging and pressing roller includes a shaft section made of metal and capable of moving in plural stages and has both a charging and attracting function and a pressing function. It is possible to simultaneously perform electrostatic force generation and pressing by holding the sheet P and pressing the sheet P against the holding roller 13 from the outer side in a state in which the charging and pressing roller is charged.

In the embodiment, the attraction device 34 configured to generate electrostatic force and attract the sheet P to the holding roller 13 is illustrated. However, the present invention is not limited to this. For example, even in other configurations such as attraction by negative pressure suction, effects same as the effects of the embodiment can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet recording apparatus comprising:
a holding roller configured to hold a recording medium on a surface thereof and rotate;
a conveying device configured to convey the recording medium along a conveying path including an outer circumferential portion of the holding roller;
a holding device configured to press the recording medium against and hold the recording medium on a surface of the holding roller;
an image forming device configured to eject ink to the recording medium held on the surface of the holding roller and form an image on the recording medium;
a reversing device configured to reverse front and rear surfaces of the recording medium; and
a controller configured to perform control to press the recording medium against the holding roller with first pressing force if the image forming device forms an image on a first surface of the recording medium and press the recording medium against the holding roller with second pressing force smaller than the first pressing force if, after the reversing device reverses the recording medium after the image is formed on the first surface of the recording medium, the image forming device forms an image on a second surface of the recording medium.

2. The apparatus according to claim 1, wherein the holding device includes:
a pressing device configured to press the recording medium against and bring the recording medium into close contact with the holding roller; and
an attraction device configured to attract the recording medium to the holding roller.

3. The apparatus according to claim 2, wherein the pressing device and the attraction device are integrally formed.

4. The apparatus according to clam 1, wherein
the holding device includes a cam arranged to be opposed to the surface of the holding roller, a contact and separation state of the cam to and from the holding roller being switched according to a rotation angle, and
the controller controls the rotation angle of the cam to thereby adjust the pressing force against the holding roller.

5. The apparatus according to claim 1, wherein
the holding device includes a pressing member arranged to be opposed to the surface of the holding roller and configured to be movable in directions in which the pressing member approaches and separates from the holding roller, and
the controller adjusts a position of the pressing member to thereby adjust the pressing force against the holding roller.

6. The apparatus according to claim 1, wherein the controller reduces the second pressing force if a printing ratio of image formation on the recording medium is higher than a threshold.

7. The apparatus according to claim 1, wherein
the image forming device includes plural inkjet heads configured to respectively supply inks of plural colors of cyan, magenta, yellow, and black, and
the controller reduces, according to a color of the printing, the second pressing force if printing is performed in the color of cyan or black.

8. The apparatus according to claim 1, wherein the controller reduces the second pressing force if conveying speed for conveying the recording medium is higher than a threshold.

9. The apparatus according to claim 1, further comprising a temperature detecting section configured to detect temperature in the apparatus, wherein
the controller reduces the second pressing force if the detected temperature in the apparatus is higher than a threshold.

10. The apparatus according to claim 1, wherein the controller reduces the second pressing force if thickness of the recording medium is smaller than a threshold.

11. The apparatus according to claim 1, wherein the controller reduces the second pressing force if resolution of the image formation is higher than a threshold.

12. An inkjet recording method comprising:
pressing a recording medium against a surface of a rotating holding roller with a first pressing force in a state in which a first surface of the recording medium is set on an outer side;
ejecting ink to the first surface of the recording medium held on the holding roller to form an image;
reversing a front and rear of the recording medium after the image formation;
pressing a second surface of the recording medium against a surface of the holding roller with a second pressing force smaller than the first pressing force and holding the recording medium on the surface of the holding roller; and
ejecting ink to the second surface of the recording medium held on the holding roller to form an image.

13. The method according to claim 12, further comprising reducing the second pressing force if a printing ratio of image formation on the recording medium is higher than a threshold.

14. The method according to claim 12, further comprising:
supplying inks of plural colors of cyan, magenta, yellow, and black in the image formation; and
reducing, according to printing ratios for the colors, the second pressing force if printing is performed in the color of cyan or black.

15. The method according to claim 12, further comprising reducing the second pressing force if conveying speed for conveying the recording medium is higher than a threshold.

16. The method according to claim 12, further comprising:
detecting temperature in an apparatus; and
reducing the second pressing force if the detected temperature is higher than a threshold.

17. The method according to claim 12, further comprising:
detecting thickness of the recording medium; and
reducing the second pressing force if thickness of the recording medium is smaller than a threshold.

18. The method according to claim 12, further comprising reducing the second pressing force if resolution of the image formation is higher than a threshold.
